(19) United States
(12) Patent Application Publication
(10) Pub. No.: US 2006/0033865 A1
(43) Pub. Date: Feb. 16, 2006

(54) Composite display unit and electric apparatus using this

(75) Inventors: Masashi Tanaka, Kyoto (JP); Yukito Toriumi, Kyoto (JP); Kenichi Shimada, Kyoto (JP)

Correspondence Address: MERCHANT & GOULD PC, P.O. BOX 2903, MINNEAPOLIS, MN, 55402-0903, US

(73) Assignee: ROHM CO., LTD., Kyoto (JP)

(21) Appl. No.: 10/528,754

(22) PCT Filed: Sep. 24, 2003
(86) PCT No.: PCT/JP03/12184

§ 371 Date: Mar. 22, 2005

(30) Foreign Application Priority Data
Sep. 25, 2002 (JP) 2002-278991

(51) Int. Cl. G02F 1/1335; G02F 1/1347

(52) U.S. Cl. 349/113; 349/74

(57) ABSTRACT

A first display element 1 and a second display element 2 are provided in a stacked configuration. The first display element 1 includes a liquid crystal panel 10 in which a liquid crystal layer 18 is held between first and second transparent substrates 11 and 12, a reflective polarization plate 3 that is provided on the side of the first transparent substrate 11 and a polarization plate 4 that is provided on the side of the second display element 2. In the example shown in FIG. 1, the reflective polarization plate 3 and polarization plate 4 are common to the first display element 1 and the second display element 2. The reflective polarization plate 3 transmits light that oscillates in a specified direction and reflects light that oscillates in a direction intersecting with the specified direction, and is joined directly to the liquid crystal panel 10 via an adhesive layer with a uniform refractive index.

### TECHNICAL FIELD

The present invention relates to a composite display unit produced by stacking two or more display elements and an electrical device employing the composite display unit. More precisely, the present invention relates to a composite display unit that renders low power consumption and space savings possible and allows respective display elements to produce a bright display with a high contrast by implementing constitution by combining a liquid crystal display element, which employs a reflective polarization plate that allows light oscillating in a specified direction to pass and reflects light that oscillates in a direction intersecting with the specified direction with another display element, as well as to an electrical device employing the composite display unit.

### BACKGROUND ART

Conventionally, in the case of an electrical device such as a rice cooker, for example, liquid crystal display elements are generally used to display the operating guide and so forth and to display the time and the like. Liquid crystal display elements of this kind generally have the structure shown in FIG. 5.

That is, in FIG. 5, electrode patterns 53 and 54 are each formed on the inside surface of two glass substrates 51 and 52 that are arranged to face each other with a gap therebetween, and orientation films 55 and 56, which orient liquid crystal molecules in a fixed direction to cover the electrode patterns 53 and 54, are provided. Two glass substrates 51 and 52 are bonded by means of seal adhesive 57 at the perimeter thereof while a fixed gap is maintained by means of a spacer (not shown). A liquid crystal layer 58 is held in a gap interposed between the two glass substrates 51 and 52 and a liquid crystal panel 61 is formed by the liquid crystal layer 58 and glass substrates 51 and 52. In addition, polarization plates 59 and 60 are provided on the outside surface of the glass substrates 51 and 52 respectively and a back light 62 is provided on the rear side opposite the observer. By applying a voltage to the opposing electrode patterns 53 and 54, the direction of alignment of the liquid crystal molecules between the electrode patterns 53 and 54 changes and the transmission and non-transmission of light is controlled together with the axes of polarization of the polarization plates 59 and 60, and the desired display is executed for each pixel.

When a detailed display such as a description for using an electrical device is produced, the electrode patterns 53 and 54 are provided so as to intersect one another in a lattice shape from a planar perspective, and the desired display is rendered by turning the dots at the points of intersection between the electrode patterns 53 and 54 ON and OFF by using a driver IC or the like (application or non-application of a voltage to the liquid crystal layer). Meanwhile, in the case of the majority of manufactured goods, this type of electrical device also combines a simple display unit such as a time display in addition to this display. Such a simple display can be produced by using a dot matrix. However, such a display is preferably always displayed even when the electrical device is not being operated, and the electrical device is preferably withdrawn from the AC power supply and driven by a cell.

However, dot-matrix displays that employ a back light consume a large amount of electrical power and cell consumption is intense. On the other hand, such simple displays do not pose such a problem although the display is sometimes dark and hard to see and do not use a backlight. There is no obstacle even with a display that is produced by reflective-type segment electrodes. For this reason, a structure in which a display element that is driven by a cell by means of segment electrodes is provided in addition to a display that employs a back light is adopted for a simple display of this kind. On the other hand, when a display element with a different display system is provided in another location, this is an impediment to miniaturization of the electrical device and, when the two display elements are stacked, the attenuation of light is severe. There is then the problem that the visibility of the display is reduced.

Furthermore, although applications are not limited to the display of an electrical device and there is a demand to use a plurality of display elements side by side such as a display element that uses an LED or the like, and a liquid crystal display element, there is the problem that the arrangement of the display elements side by side takes up space and one of the display elements cannot be seen when same are stacked.

As mentioned earlier, when a plurality of types of display elements are arranged side by side in cases where there is no need for a simultaneous display but a plurality of types of displays are to be implemented, there is the problem that such an arrangement takes up space and, when the display elements are stacked, there is the problem that the display of the lower display element is hard to see.

In addition, a liquid crystal display unit in which a liquid crystal panel constituting a liquid crystal display element is stacked in two levels, for example, to enable separate displays is disclosed in Japanese Patent Application Laid Open No. H6-339575, for example. However, the liquid crystal display element disclosed in this publication attenuates half the light by means of a polarization plate and affords further attenuation when the polarization plate contains a light-absorbing pigment. Further, the light of the back light is also attenuated by means of the liquid crystal panel. As a result, in the case of the liquid crystal display unit that is disclosed inth is publication, there is the problem that the display of the lower liquid crystal panel in particular is hard to see and that both display images cannot be seen clearly.

In addition, because light passes through the polarization plate a total of four times in the reflective-type liquid crystal display element before being emitted, the usage efficiency of light is even poorer. As a result, it is extremely difficult to improve the visibility of the reflective-type liquid crystal display element and the other display element by overlapping these display elements.

Meanwhile, the present inventor is developing a liquid crystal display element that combines a liquid crystal panel with a reflective polarization plate that transmits light that oscillates in a specified direction and reflects light that oscillates in a direction intersecting with the specified direction, which acts as a mirror device by not including a material that readily produces diffused reflection such as beads or similar in an adhesive that bonds the liquid crystal panel and the reflective polarization plate and by using an adhesive with a substantially uniform refractive index, and which renders a bright display with a small amount of dullness and so forth possible. The liquid crystal display element is disclosed in Japanese Patent Application Laid Open No. 2001-350822. Moreover, it was found that, in the case of this liquid crystal display element that may serve as a mirror display unit, both display images can be seen clearly even when the liquid crystal display element is overlapping another liquid crystal panel or the like.

### DISCLOSURE OF THE INVENTION

Therefore, an object of the present invention is to provide a composite display unit that makes it possible to conserve space and clearly display each of a plurality of display elements while individually or simultaneously displaying displays of a plurality of types.

A further object of the present invention is to provide, by implementing a constitution that makes it possible to render one of the display elements that are stacked in multiple levels a mirror device, a composite display unit that has a constitution that also allows another liquid crystal display element to be obtained by either a transmissive-type or reflective-type system and which can be afforded a constitution in which the other display element is completely shielded.

The composite display unit according to the present invention is a composite display unit having a first display element and a second display element that is provided overlapping the first display element, wherein the first display element comprises a liquid crystal panel in which a liquid crystal layer is held between first and second transparent substrates; and a reflective polarization plate that transmits light that oscillates in a specified direction and reflects light that oscillates in a direction intersecting with the specified direction and which is disposed on the liquid crystal panel on the side of the first transparent substrate; and the reflective polarization plate is directly joined to the liquid crystal panel via an adhesive layer with a uniform refractive index.

In the case of the composite display unit, a reflective polarization plate is used as at least one polarization plate of a first display element. As a result, absorption by the pigment of the conventional polarization plate can also be reduced while the light amount of the back light is absorbed very efficiently. Therefore, even when another element is stacked on the first display element, an extremely bright and clear display can be produced and a plurality of display elements can also be operated at the same time. In addition, the reflective polarization plate is especially bonded via an adhesive layer with a uniform refractive index and, therefore, light is not scattered by the adhesive layer, fading and dullness of the display can be suppressed and the contrast of the display can be increased further.

For example, when this composite display unit is used as the display unit of an electric rice cooker, the first display element can be a display unit that is used for an operating guide of a dot-matrix display and a second display element can be a display unit that executes a simple display that displays the time by means of a segment display. Because a commercial AC supply is used when the first display element is operated, power consumption is not a problem each time a display is implemented while driving a driver IC and igniting the back light. On the other hand, by implementing the display of the second display element by means of cell driving during periods in which the rice cooker is not used and rendering the first display element a mirror device, a reflective-type display element is rendered even in the absence of a back light and a display can be implemented by means of external light. As a result, power conservation can be implemented.

In a preferred embodiment, the second display element comprises a liquid crystal panel in which a liquid crystal layer is held between third and fourth transparent substrates, wherein the third transparent substrate of the second display element is provided on the side of the second transparent substrate of the first display element and a polarization plate is further provided on the side of the fourth transparent substrate.

Here, the polarization plate may be the reflective polarization plate mentioned earlier or a conventionally used absorption polarization plate and signifies a polarization plate that transmits light that oscillates in a certain specified direction and that does not transmit light that oscillates in a direction intersecting with the specified direction.

In another preferred embodiment, the second display element is a display element that is formed by a liquid crystal panel in which a liquid crystal layer is held between third and fourth transparent substrates or by light-emitting diodes or cold-cathode tubes and the first display element is constituted such that a polarization plate is provided on the second transparent substrate side and the first display element is provided stacked on the display surface of the second display element.

In addition, the present invention provides an electrical device in which the composite display unit is mounted. As a result of this constitution, while the electrical device is afforded a neat design through compaction of the space of the display unit, each of a plurality of types of displays can be rendered clearly by means of a display unit in which a plurality of types of display are made to overlap one another.

### BRIEF DESCRIPTION OF THE DRAWINGS

FIG. 1 is an explanatory view showing the cross-sectional structure of an embodiment of the composite display unit of the present invention;

FIG. 2 is an explanatory view showing the cross-sectional structure of another embodiment of the composite display unit of the present invention;

FIG. 3 is an explanatory view showing the cross-sectional structure of another embodiment of the composite display unit of the present invention;

FIG. 4 is an external perspective view of an example of an electrical device employing the composite display unit of the present invention; and

FIG. 5 is an explanatory view showing the cross-sectional structure of a conventional liquid crystal display unit.

### BEST MODE FOR CARRYING OUT THE INVENTION

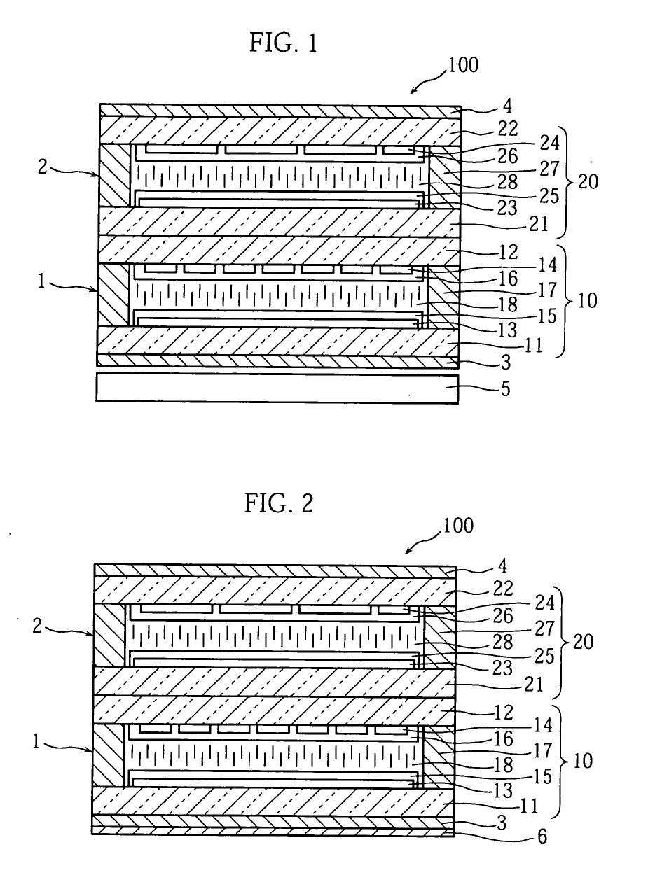

FIG. 1 shows a first embodiment of the composite display unit of the present invention. As shown in FIG. 1, the composite display unit 100 is provided by over lapping the first display element 1 and second display element 2. The first display element 1 is constituted comprising a liquid crystal panel 10 in which a liquid crystal layer 18 is held between first and second transparent substrates 11 and 12 respectively, a reflective polarization plate 3 that is provided on the side of the first transparent substrate 11 and a polarization plate 4 that is provided on the side of the second display element 2. In the example shown in FIG. 1, the reflective polarization plate 3 and polarization plate 4 are common to the first display element 1 and the second display element 2. This reflective polarization plate 3 is characterized in that same transmits light that oscillates in a specified direction and reflects light that oscillates in a direction intersecting with the specified direction and is joined directly to a liquid crystal panel 10 via an adhesive layer (not shown) with a uniform refractive index.

The liquid crystal panel 10 of the first display element 1 is constituted such that first and second transparent substrates 11 and 12 respectively are bonded via a constant gap by a seal adhesive 17 at the perimeter thereof and the liquid crystal layer 18 is formed in the gap between the first and second transparent substrates 11 and 12 respectively by filling the gap with TN (Twisted Nematic) liquid crystals, for example. The first and second transparent substrates 11 and 12 are formed such that a plurality of first and second transparent electrodes 13 and 14 respectively are formed on opposite faces in the form of respective parallel belts, for example, and both electrodes 13 and 14 are formed to intersect with each other and in the form of a lattice when viewed in planar fashion. Further, opposing parts where the first and second transparent electrodes 13 and 14 respectively intersect one another form dots (pixels) and light and dark displays can be produced by controlling the application and non-application of the two opposing electrodes. The application and non-application of a voltage is controlled by means of a driver IC (not shown).

The first and second transparent electrodes 11 and 12 respectively are formed by means of a glass or polyethylene terephthalate substrate or the like, for example. The first and second transparent electrodes 13 and 14 are formed by patterning by using photo etching after forming an ITO film, for example, by means of vacuum deposition or similar. Further, orientation films 15 and 16 are each formed on the first and second transparent electrodes 13 and 14 respectively. The surfaces of the orientation films 15 and 16 are rubbed so that the orientation directions thereof are orthogonal to each other and, as a result, by filling the gap between the first and second transparent substrates 11 and 12 respectively with TN liquid crystals, the liquid crystal molecules are arranged in a state of being twisted 90° from the side of the first transparent substrate 11 toward the side of the second transparent substrate 12. In this state, if a voltage is applied to the first transparent electrode 13 and second transparent electrode 14 of a certain dot, the liquid crystal molecules in the area that is sandwiched between the two electrodes are released from their twisted state and assume a vertical orientation. Further, the twist angle can be set at 90° or more by adjusting the addition amount of the chiral agent that is added to the liquid crystal layer 18.

Meanwhile, a reflective polarization plate 3 is bonded to the opposite side of the first transparent substrate 11 from the liquid crystal layer 18. The reflective polarization plate 3 transmits light that oscillates in a specified direction but reflects light that oscillates in a direction intersecting with the specified direction. The reflective polarization plate 3 is bonded to a first transparent substrate 11 via an adhesive layer (an acrylic resin, for example) with a uniform refractive index (not shown). In this embodiment, another polarization plate is a polarization plate 4 that is provided on the upper face of the second display element 2 and is shared with the second display element 2. An absorption polarization plate can be used as the polarization plate 4. The polarization plate 4 and reflective polarization plate 3 have a parallel nicol relationship in which the axes of polarization are the same direction, for example.

The reflective polarization plate 3 is constituted as a dielectric multi-layered film with form birefringence, for example. The dielectric multi-layered film is rendered by alternately laminating, in a plurality of sets, two macromolecular layers with different light elastic moduli, such as PEN (2,6-polyethylene naphthalate) and coPEN (70-naphthalate/30-terephthalate copolyester), for example, and then extending the stacked structure by a multiple of five, for example. These macromolecular layers have a different refractive index in the direction of extension but have the same refractive index in a direction that is orthogonal to the direction of extension, each set having form birefringence as a result of extension in one direction. As a result, whereas light oscillating in the direction of extension is reflected due to the difference in the refractive index, light that oscillates in a direction that is orthogonal to the direction of extension can be transmitted. Further, because reflection occurs when the film thickness of the two macromolecular layers is a half wavelength, if a plurality of sets with different film thicknesses are laminated, light can be reflected over a wide wavelength range with respect to light that oscillates in the direction of extension.

In this embodiment, the second display element 2 is constituted comprising a liquid crystal panel 20 that executes a segment display in which a liquid crystal layer 28 is held between the third and fourth transparent substrates 21 and 22; a reflective polarization plate 3; and an absorption polarization plate 4 that is provided on the surface side of the liquid crystal panel 20. The liquid crystal panel 20 that executes the segment display is rendered as a result of bonding the third and fourth transparent substrates 21 and 22 respectively by means of seal adhesive 27 at the periphery thereof via a fixed gap in the same way as the liquid crystal panel 10 of the first display element 1 and forming a liquid crystal layer 28 by filling the interval between the third and fourth transparent substrates 21 and 22 respectively with TN liquid crystals, for example. Third and fourth transparent electrodes 23 and 24, which area common electrode and a segment electrode respectively, are formed on the opposing faces of the third and fourth transparent substrates 21 and 22 respectively and orientation films 25 and 26 are provided on the surfaces of the third and fourth transparent electrodes 23 and 24 respectively.

The polarization plate 4 that is shared with the first display element 1 is bonded to the surface on the opposite side of a fourth transparent substrate 22 from the liquid crystal layer 28 by means of an acrylic resin or the like, for example. The polarization plate 4 transmits light that oscillates in a specified direction but absorbs light oscillating in a direction intersecting with the specified direction, and the above-mentioned reflective polarization plate or the conventionally used absorption polarization plate can be used. Although the reflection by the reflective polarization plate is too bright and the display is hard to see in the case of a display unit that is used when external light such as solar light is strong, a clear display is preferably rendered by using a reflective polarization plate in a display unit that is used when reflected light is undesirable in the case of a guide or the like. The reflective polarization plate is formed by extending a thin film of a poly vinyl alcohol, for example, while heating same and then causing same to permeate a solution called an iodine-containing H ink.

In the first embodiment shown in FIG. 1, a second display element 2 is provided on the display-face side of the first display element 1 and a back light 5 is provided on the rear side of the first display element 1, that is, on the reverse side of the reflective polarization plate 3. The back light 5 maybe rendered by directly providing a light emitting diode, a white fluorescent lamp, a white halogen lamp, or the like, and may be of a type that allows light from a light emitting source to enter via the side of a waveguide to be irradiated uniformly via the waveguide surface.

According to the present invention, the reflective polarization plate 3 is used as at least one polarization plate that is common to each of the first and second display elements 1 and 2 respectively and the reflective polarization plate 3 is provided on the side of the back light 5. Therefore, of the light emitted by the back light 5, the light of a component that oscillates in a specified direction (the light that follows that the axis of polarization of the reflective polarization plate 3) is transmitted by the reflective polarization plate 3 and the light of a component that is orthogonal to this direction is reflected by the reflective polarization plate 3. The reflected light is repeatedly reflected by means of the waveguide (light source) and the light of a component that comes to oscillate in the specified direction as a result of a change in the oscillation direction is transmitted by the reflective polarization plate 3. Therefore, whereas half of the light of the back light is absorbed by the conventional absorption polarization plate and a portion of the transmitted light is absorbed by means of mixed pigment or the like at the polarization plate such that the attenuation increases and the display screen grows dark, with the constitution of the present invention, light that is eliminated as a result of the repeated reflection at the side of the back light 5 is excluded and the reflective polarization plate 3 can be made to transmit light, whereby an extremely bright display can be implemented.

Further, as a result of the constitution shown in FIG. 1, the composite display unit 100, which comprises liquid crystal display elements of a two-level series system, is obtained. In this case, the first display element 1 can be a dot-display liquid crystal display element and the second display element 2 can be a segment-display liquid crystal display element. Thus, during operation with an AC supply, a display that may be used by the user such as an operating guide can be executed by implementing only the dot display of the first display element 1 or both the dot display of the first display element 1 and the segment display of the second display element 2. However, when driving is performed using a cell, the supply of the first display element 1 is disconnected so that only the minimum display such as a time display is rendered by the segment display constituting the second display element 2, where by power consumption can be suppressed. In addition, because the transmittance of the first display element 1 is higher than in the case where an absorption polarization plate is employed, there is no loss of light and, because the reflective polarization plate is provided via an adhesive layer with a uniform refractive index, the scattering of light is suppressed and, to the same degree, the dullness and blurring of a dark display is suppressed and the contrast of the first display element 1 can be raised, whereby the dot display of the first display element 1 is extremely easy to see.

The operation of the composite display unit 100 shown in FIG. 1 will be described in specific terms next.

First, a case where the first display element 1 and the second display element 2 both use TN liquid crystals and where the reflective polarization plate 3 and the polarization plate 4 are in a parallel nicol relationship will be described.

In this case, the liquid crystal layers of the first and second display elements 1 and 2 respectively each undergo 90° optical rotation. Therefore, linear polarized light that is optically rotated through 180° by the two liquid crystal layers 18 and 28 and which enters via either of the polarization plates 3 and 4 is transmitted by the other polarization plate as is. Now, when the operating guide or the like of an electric rice cooker, for example, is displayed by the first display element 1, because the rice cooker is being operated, the rice cooker is connected to a commercial AC supply and, therefore, power consumption is not such a problem. Therefore, the back light 5 is ignited and the first display element 1 is driven by the driver IC to display the desired letters and so forth. When a voltage is applied between transparent electrodes constituting the dots of letters and so forth that are to be displayed, the liquid crystal molecules in these parts rise and 90° optical rotation does not take place. 90° optical rotation is only produced by the liquid crystal layer of the second display element 2. Therefore, light cannot be transmitted by the polarization plate 4 and, hence, desired letters and so forth of a dark color can be displayed on a bright background of dots to which a voltage is applied.

Furthermore, in cases where the time and the like is displayed by means of cell driving and so forth, for example, by means of the second display element 2, a voltage is applied to all the dots of the first display element 1 instead of using a back light. Here, optical rotation by the first display element 1 does not take place and, if a voltage is not applied to the liquid crystal layer 28 of the second display element 2, only 90° optical rotation of the second display element 2 takes place. Therefore, the light that enters via the surface of the second display element 2 enters a mirror state as a result of being reflected by the reflective polarization plate 3 on the side of the first display element 1. On the other hand, when a voltage is applied to required segments in order to produce a display by means of the second display element 2, liquid crystal molecules rise in these segments and do not effect optical rotation. The light passing through these segments ultimately does not undergo optical rotation by the first and second display elements 1 and 2 respectively. Therefore, the light is transmitted by the reflective polarization plate 3, which is in a parallel nicol relationship, and a dark color results. As a result, the image that is to be displayed by the second display element 2 can be displayed by means of a dark color on a background of the reflected light that is reflected by the first display element 1.

That is, the composite display unit 100 is able to cause the first display element 1 to operate as a mirror and the second display element 2 to operate as a reflective-type liquid crystal display element while the first and second display elements 1 and 2 respectively are both transmissive-type liquid crystal display elements and a bright display can be executed even when a back light is not used. Although, in the above example, the second display element 2 is shown in an example in which a simple display of the time or the like is implemented by means of segment electrodes, this display being used based on the conventional idea of power conservation, the composite display unit 100 is a reflective-type display unit that is able to deliver an extremely clear display even when a back light is not used, as per the above description. Therefore, the second display element 2 can also be a normal dot matrix display instead of a segment display.

Further, although a mirror is constituted by applying a voltage to all the dots of the first display element 1 in the above example, because a current barely flows even when a voltage is applied, consumption of the cell barely takes place. However, if the reflective polarization plate 3 and polarization plate 4 are disposed in an orthogonal nicol relationship, a mirror is constituted even when a voltage is not applied to the first display element 1 and a clear display by the second display element 2 can similarly be produced. In this case, when the display is produced by the first display element, by applying a voltage to the other dots rather than applying a voltage to the dots that are to be displayed, a so-called positive display with a dark color on a bright background like that mentioned above can be implemented and, if a voltage application method like that mentioned above is adopted, an outline or color display can be rendered on a dark-colored background, i.e. a so-called negative display can also be implemented. That is, the same display can be implemented if the above voltage application method is reversed when both polarization plates are in an orthogonal nicol relationship.

Further, the displaying of the first display element 1 and second display element 2 can also be executed at the same time. In this case, in a state that is the same as an operation that employs the back light, only the dots or segments to which a voltage is applied in the first display element 1 and the second display element 2 constitute a dark display (with respect to the liquid crystal panel, it is necessary to ensure that a voltage is not applied to both the first display element land the second display element 2 in the same positions in a vertical direction) and the display of the first and second display elements 1 and 2 respectively can be implemented on a bright background. In this case, because there is a slight difference in the depth direction in the display image, a three-dimensional display can be implemented. For this reason also, the second display element 2 is not limited to a segment display and a combined display can be implemented by the first display element 1 and second display element 2 as a dot display.

In addition, the present invention is not limited to two display elements. By combining further display elements, a more three-dimensional display can also be achieved. Because a reflective polarization plate is used for the first display element on the back-light side even when liquid crystal display panels are stacked in a plurality of levels, the light of the back light can be effectively absorbed and an extremely bright display can be delivered. As a result, even when liquid crystal panels are stacked in a plurality of levels, the display of any liquid crystal panel can also be rendered a clear display.

FIG. 2 shows a second embodiment of the composite display unit 100 of the present invention. The composite display unit 100 of this embodiment is constituted as a reflective-type composite display unit. As shown in FIG. 2, the composite display unit 100 of this example comprises no back light but comprises a light absorption layer 6 that is formed glued to the reflective polarization plate 3. Further, the remaining constitution is the same as that of the first embodiment shown in FIG. 1. The same reference symbols have been assigned to the same parts and a description thereof has therefore been omitted.

The light absorption layer 6 is formed by sticking on a black film, for example, or coating with a resin containing a black colorant, and so forth.

In this case, if the polarization plate 4 and reflective polarization plate 3 are arranged in an orthogonal nicol relationship, for example, light that oscillates in the same direction as the axis of polarization of the polarization plate 4 after external light reaches the polarization plate 4 passes within the second display element 2 and first display element 1, thereby undergoing 180° optical rotation, and is reflected by the reflective polarization plate 3. The reflected light follows the opposite route, passing through the first display element 1 and second display element 2 and is displayed brightly as a result of being emitted by the polarization plate 4. On the other hand, the dots to which a voltage is applied on the first display element 1 or second display element 2 undergo 90° optical rotation and light that is transmitted by the reflective polarization plate 3 disposed in an orthogonal nicol relationship is absorbed by the light absorption layer 6, thereby producing a dark display. Therefore, by applying a voltage to desired dots, the dots form a dark display and a positive display with a bright background can be rendered. This relationship is the same for the first display element 1 and the second display element 2 and a positive display can be rendered in the same way when either the first display element 1 or the second display element 2 is operated.

Further, in cases where the first display element 1 and second display element 2 are operated at the same time, when a voltage is simultaneously applied to dots that stand in a line in the vertical direction of the two display elements, 180° optical rotation takes place to produce a bright display. Therefore, although a display cannot be executed, if the display parts of the first and second display elements 1 and 2 respectively are established beforehand to not overlap each other, a three-dimensional display can also be produced in the same way as in the above-mentioned case of the transmissive-type display. So to in this case, because there is no absorption by the reflective polarization plate 3, there is no loss of light and the reflective polarization plate 3 is provided via an adhesive layer (not shown) with a uniform refractive index. Therefore, the scattering of light is suppressed and, to the same degree, the contrast of the first display element 1 can be increased by suppressing the blurring of the dark display and dullness and so forth is not produced, whereby an extremely bright display can be delivered. As a result, the number of display elements is not limited to two. Three or more display elements can also be stacked in levels.

Further, in this case also, if the relationship between the polarization plate 4 and the reflective polarization plate 3 is such that same are in a parallel nicol relationship rather than in an orthogonal nicol relationship and opposite voltages are applied to the polarization plate 4 and the reflective polarization plate 3, exactly the same display can be produced. Further, if the voltage application method is the same and only the relationship between the axes of polarization of the two polarization plates are changed, the relationship between a positive display (a display with black or color on a bright background) and a negative display (a display with a bright color on a dark background) can also be changed.

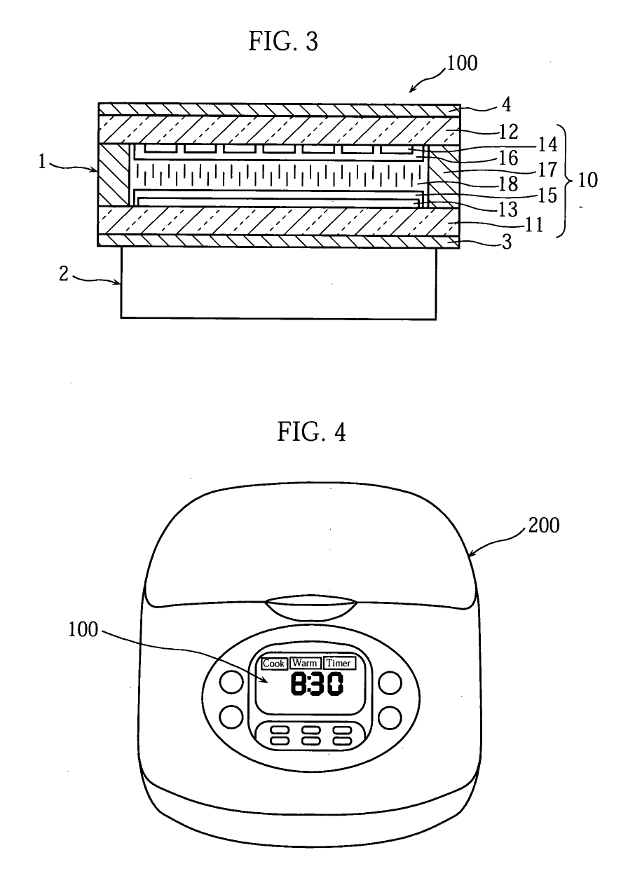

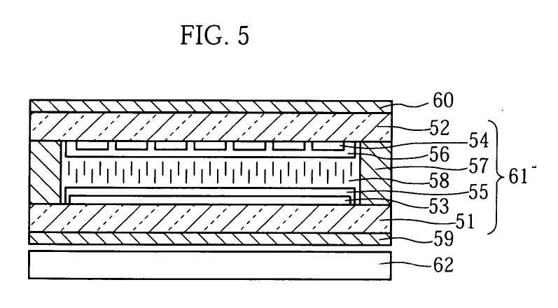

FIG. 3 shows a third embodiment of the composite display unit 100 of the present invention. In this embodiment, the first display element 1, which is rendered by providing the reflective polarization plate 3 and polarization plate 4 on both sides of the liquid crystal panel 10 with the same constitution as that mentioned earlier is constituted to overlap the second display element 2. In addition to it being possible for the second display element 2 to employ a liquid crystal display element that is produced by providing a polarization plate on both sides of the liquid crystal panel 20 in which a liquid crystal layer is held between two transparent substrates that is the same as the second display element 2, for example, it is also possible to combine a display element that is constituted by lining up light-emitting diodes (LED) in the form of a matrix or a display element that is constituted by arranging cold cathode tubes, with the existing display element.

So to in this constitution, if TN liquid crystals, for example, are used and the polarization plate 4 of the first display element 1 and the reflective polarization plate 3 are in an orthogonal nicol relationship, the reflective polarization plate 3 is provided on the first display element 1 on the side of the second display element 2. Therefore, the light emitted by the second display element 2 can be guided to the first display element 1 without very much attenuation and the light undergoes 90° optical rotation by means of the liquid crystal layer 18 before being transmitted by the polarization plate 4. As a result, even when the first display element 1 is stacked on the second display element 2, the display of the second display element 2 can be adequately seen via the first display element 1. On the other hand, when the first display element 1 is used as a shutter for shielding the display of the second display element 2, a voltage is applied to all the dots of the first display element 1. As a result, there is no optical rotation by the liquid crystal layer 18, light cannot be transmitted by the two polarization plates 3 and 4 in an orthogonal nicol relationship and the external light entering from the side of the display face is also completely reflected. Hence, the first display element 1 is a mirror and the display of the second display element 2 is shielded. Further, in FIG. 3, the second display element 2 is provided in contact with the reflective polarization plate 3 but need not necessarily be in direct contact with the reflective polarization plate 3. The second display element 2 may be disposed with a gap between same and the reflective polarization plate 3.

On the other hand, when the display is to be produced by means of the first display element 1, the first display element 1 can be made to produce a display as a reflective-type display by substituting the second display element 2 for the back light of a whole-screen display and turning the second display element 2 completely off. That is, in order to render the first display element 1 a reflective-type display, if the two polarization plates 3 and 4 of the first display element 1, for example, are in a parallel nicol relationship and a voltage is applied only to the dots that are to be displayed, the dots constituting the background to which a voltage is not applied undergo 90° optical rotation as a result of the liquid crystal layer 18 and are reflected by the reflective polarization plate 3, whereby a bright display is produced. However, the dots to which a voltage is applied do not undergo optical rotation and are transmitted by the reflective polarization plate 3 to produce a dark display, whereby an image can be displayed by means of a dark display on a bright background. Further, in the above example, similarly to the transmissive-type case, the relationship between the axes of polarization of the two polarization plates 3 and 4 is not limited to this example. Other constitutions can also be implemented in accordance with the relationship of the voltage application, the display form (positive display or negative display). Further, when the second display element 2 is employed instead of a back light, it is possible to make the second display element 2 operate as a transmissive-type display that is the same as that mentioned earlier.

In the case of the embodiment shown in FIG. 3, the first display element 1 located on the second display element 2 has a higher transmittance than in the case of a conventional liquid crystal display element that employs an absorption polarization plate. There is therefore no loss of light. In addition, because the reflective polarization plate 3 is provided via an adhesive layer with a uniform refractive index, the scattering of light is suppressed and, to the same degree, the contrast of the first display element 1 can be increased by suppressing the dullness and blurring of the dark display and, even when the second display element 2 is disposed overlapping the first display element 1, the display of the second display element 2 can be adequately seen.

Furthermore, while the image display is executed by using a portion of the dots of the first display element 1, the other parts can also be used as a mirror and, assuming a full-screen mirror display, the first display element 1 can also be used as a shutter.

### INDUSTRIAL APPLICABILITY

As shown in FIG, 4, the composite display unit 100 shown in FIGS. 1 to 3 can be used by being integrated into an electrical device 200 such as the above-mentioned electric rice cooker, an electric refrigerator, a microwave oven, an oven range, and an electric washer, for example. By using the composite display unit 100 by integrating same into such an electrical device 200, a simple display of the time or the like can be used by overlapping separate display elements at the same time as the manual for usage of the electrical device 200. Moreover, in addition to these household appliances, the composite display unit 100 can also be used through integration in electrical goods such as an audio device or AV device, or the like.

1. A composite display unit having a first display element and a second display element that is provided overlapping the first display element, wherein the first display element comprises:
a liquid crystal panel in which a liquid crystal layer is held between first and second transparent substrates; and
a reflective polarization plate that transmits light that oscillates in a specified direction and reflects light that oscillates in a direction that is intersecting with the specified direction and which is disposed on the liquid crystal panel on the side of the first transparent substrate; and
wherein the reflective polarization plate is directly joined to the liquid crystal panel via an adhesive layer with a uniform refractive index.

2. The composite display unit according to claim 1, wherein the reflective polarization plate is constituted as a dielectric multi-layered film with birefringence.

3. The composite display unit according to claim 1, wherein the second display element comprises:
a liquid crystal panel in which a liquid crystal layer is held between third and fourth transparent substrates, and
wherein the third transparent substrate of the second display element is provided on the side of the second transparent substrate of the first display element and a polarization plate is further provided on the side of the fourth transparent substrate.

4. The composite display unit according to claim 3, wherein the polarization plate provided on the side of the fourth transparent substrate is a reflective polarization plate or an absorption polarization plate.

5. The composite display unit according to claim 1, wherein the first display element performs a dot-matrix display and the second display element performs a segment display.

6. The composite display unit according to claim 1, wherein the second display element is a display element that is formed by a liquid crystal panel in which a liquid crystal layer is held between two transparent substrates or by light-emitting diodes or cold-cathode tubes, and the first display element is constituted such that a polarization plate is further provided on the side of the second transparent substrate and the first display element is provided stacked on the display surface of the second display element.

7. An electrical device in which the composite display unit according to claim 1 is mounted.
